(19) United States
(12) Patent Application Publication
(10) Pub. No.: US 2005/0180715 A1
(43) Pub. Date: Aug. 18, 2005

(54) Light tunnel

(76) Inventors: Ke-Shu Chin, Jhonghe City (TW); Yu-Hsien Fang, Taipei (TW); Chih-Neng Chang, Taipei (TW); An-Hwa Yu, Taoyuan County (TW); Chung-Lung Lee, Sinjhuang City (TW)

Correspondence Address: BIRCH STEWART KOLASCH & BIRCH, PO BOX 747, FALLS CHURCH, VA, 22040-0747, US

(21) Appl. No.: 10/868,979

(22) Filed: Jun. 17, 2004

(30) Foreign Application Priority Data
Feb. 12, 2004 (TW) 093103401

(51) Int. Cl. G02B 6/00

(52) U.S. Cl. 385/133

(57) ABSTRACT

A light tunnel includes a first optical device, a second optical device, a third optical device, and a fourth optical device. The second optical device is adhered to the first optical device at a first angle. The third optical device is adhered to the second optical device at a second angle. The fourth optical device is adhered to the third optical device at a third angle. At least two of the optical devices are inserted to each other, and the optical devices form a light passing space. Highly reflective layers are formed on the sides of the optical devices facing the light passing space.

### BACKGROUND OF THE INVENTION

1. Field of Invention

The invention relates to a light tunnel and, in particular, to a light tunnel formed through an insertion type combination.

2. Related Art

Under the requirements of large-area, minimized, and light systems, image projection systems have become the hottest field of the opto-electric industry.

In a digital light processor (DLP) 2 as shown in FIG. 1, a light beam emitted by a light source 21 first passes through a light tunnel 22 and then a red-green-blue (RGB) color wheel 23, projecting onto a digital micro-mirror device (DMD) 24. After reflection, the light forms an image on a screen 25. The color wheel 23 is a field sequential color wheel or a sequential color recapture color wheel.

The light tunnel 22 is used to guide (e.g. changing the propagation direction of) and converge light. Moreover, the light tunnel 22 homogenizes the brightness distribution and controls the aspect ratio of the projected light. Most manufacturers also call the light tunnel 22 in the name of light rod, light pipe, or rod lens.

With reference to FIG. 2, a conventional light tunnel 22 is made by fixing four panes of glasses 211 on a tool, followed by applying an adhesive 222 (e.g. UV gel) to the joints of the glasses. This fixes the four panes of glasses 221 into a light tunnel 22.

However, since each glass pane is fixed using the adhesive force, the light tunnel 22 can easily break due to the low mechanical strength of the adhesive 222 at high temperatures. Moreover, since the conventional light tunnel 22 is directly formed by gluing four panes of glasses 221 together, a certain tool is required for fixing the positions. There is therefore the problem of imprecise alignment.

### SUMMARY OF THE INVENTION

In view of the foregoing, the invention is to provide an insertion type combination to form a light tunnel with a strengthened mechanical force.

To achieve the above, the disclosed light tunnel includes a first optical device, a second optical device, a third optical device, and a fourth optical device. The second optical device is adhered to the first optical device at a first angle. The third optical device is adhered to the second optical device at a second angle. The fourth optical device is adhered to the third optical device at a third angle. At least two of the optical devices are inserted to each other, and the optical devices form a light passing space. Highly reflective layers are formed on the sides the optical devices facing the light passing space.

The disclosed light tunnel has at least two optical devices combined by insertion. In comparison with the prior art, the invention has at least two optical devices inserted to each other so that it will not break due to the stronger mechanical strength of the glass in the insertion parts than that of the adhesive at high temperature. That is, in addition to using an adhesive to fix optical devices, the invention further utilizes the insertion mechanism to enhance the mechanical supportive force of the whole light tunnel. Therefore, the invention can increase the reliability of the light tunnel. The optical devices with insertion parts also help improve the precision of the positioning and assembly of the light tunnel.

### BRIEF DESCRIPTION OF THE DRAWINGS

The invention will become more fully understood from the detailed description given hereinbelow illustration only, and thus is not limitative of the present invention, and wherein:

FIG. 1 is a schematic view of the basic structure of a conventional digital light processor;

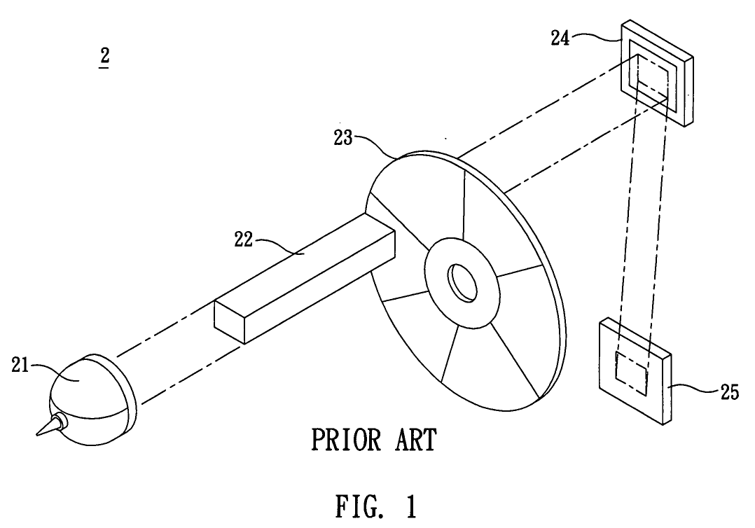

FIG. 2 is a schematic three-dimensional view of a conventional light tunnel;

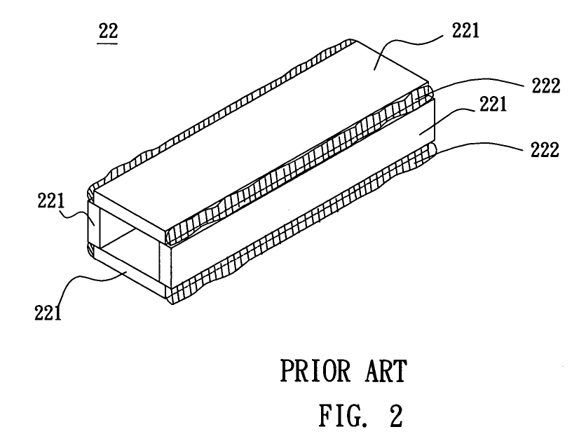

FIG. 3 is a schematic three-dimensional view of the disclosed light tunnel;

FIG. 4 is a cross section perpendicular to the light propagation direction;

FIG. 5 is a schematic view of the optical devices in the disclosed light tunnel;

FIG. 6 is another three-dimensional view of the disclosed light tunnel;

FIG. 7 is yet another three-dimensional view of the disclosed light tunnel;

FIGS. 8 to 11 are another schematic views of the optical devices in the disclosed light tunnel;

FIG. 12 is a schematic three-dimensional view of a trapezoid light tunnel of the invention; and

FIG. 13 is a schematic three-dimensional view of the light tunnel with multiple tunnels according to the invention.

### DETAILED DESCRIPTION OF THE INVENTION

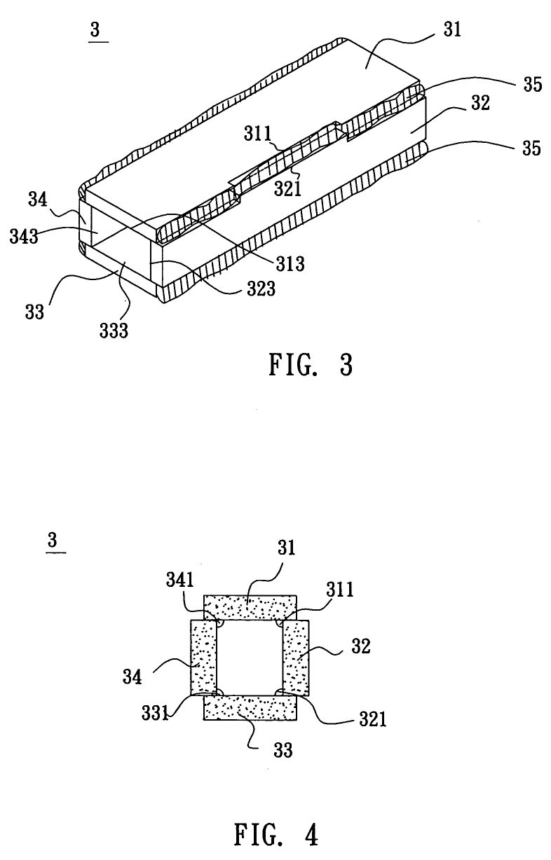

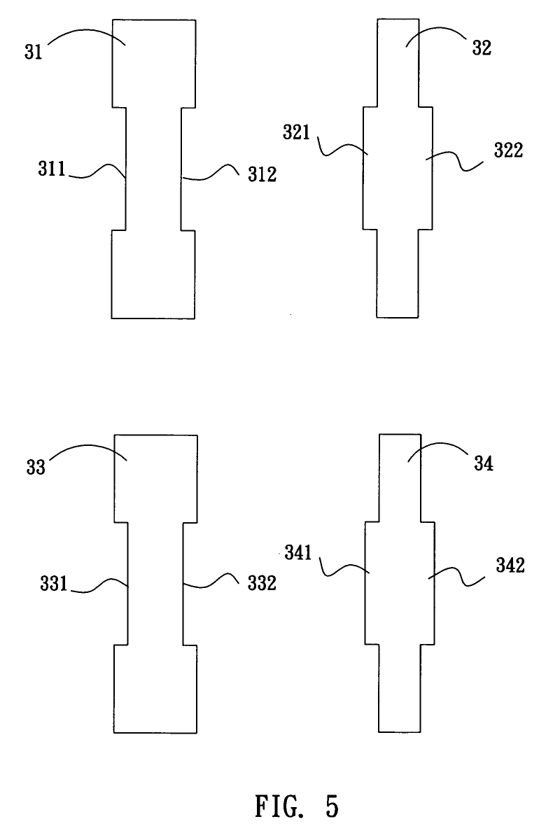

First, we use FIGS. 3 and 4 to show a first preferred embodiment of the disclosed light tunnel.

As shown in FIG. 3, the light tunnel 3 contains a first optical device 31, a second optical device 32, a third optical device 33, and a fourth optical device 34.

As shown in FIG. 4, the second optical device 32 is adhered to the first optical device 31 at a first angle 310. The third optical device 33 is adhered to the second optical device 32 at a second angle 320. The fourth optical device 34 is adhered to the third optical device 33 at a third angle 330. The first optical device 31 is adhered to the fourth optical device 34 at a fourth angle 340. The first angle 310, the second angle 320, the third angle 330, and the fourth angle 340 has a sum of 360 degrees.

With further reference to FIG. 3, the light tunnel 3 has at least two optical devices inserted into each other. In the current embodiment, the first optical device 31 and the second optical device 32 are inserted into each other. The first optical device 31 has a first insertion part 311 and the second optical device 32 has a second insertion part 321. The first insertion part 311 and the second insertion part 321 are inserted into each other. Other optical devices without insertion parts are combined with others using an adhesive 35 at the joints.

In the current embodiment, the adhesion of the light tunnel is achieved by applying an adhesive 35 at the joints of the optical devices. However, the adhesive 35 can also be applied to the insertion parts of the optical devices. The adhesive 35 can be a light-cured adhesive or heat-cured adhesive. Appropriately increasing the amount of the adhesive 35, the mechanical strength of the light tunnel 3 under high temperatures greatly increases. Therefore, in this embodiment, the joints of optical devices in the light tunnel are applied with the adhesive 35.

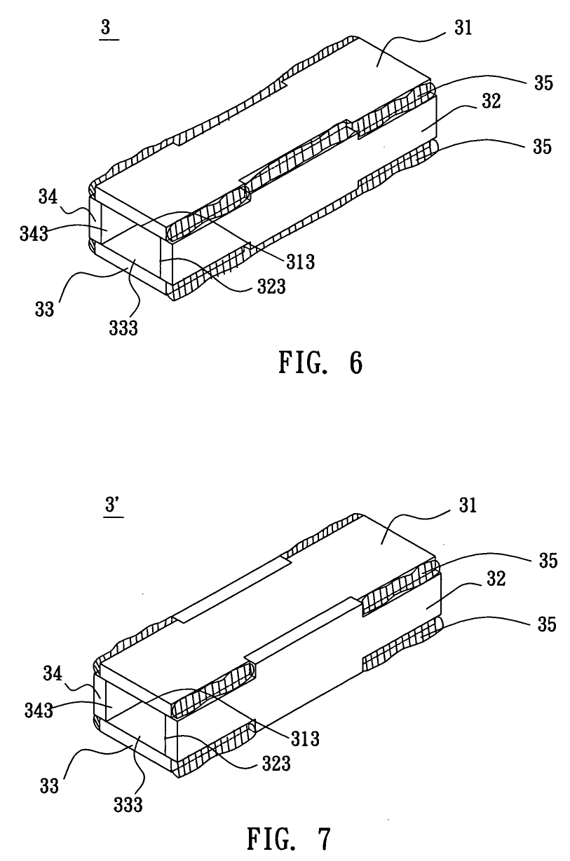

In the following, we use FIG. 5 to explain a second embodiment of the invention.

In addition to two optical devices inserted into each other, the light tunnel 3 of the invention can have a third optical device and even a fourth inserted into one another. In the current embodiment, the light tunnel 3 has the four optical devices inserted into each other.

As shown in FIG. 5, the first optical device 31 has at least a first insertion part 311 and an eighth insertion part 312; the second optical device 32 has at least a second insertion part 321 and a third insertion part 322, the first optical device 33 has at least a fourth insertion part 331 and a fifth insertion part 332, and the fourth optical device 34 has at least a sixth insertion part 341 and a seventh insertion part 342.

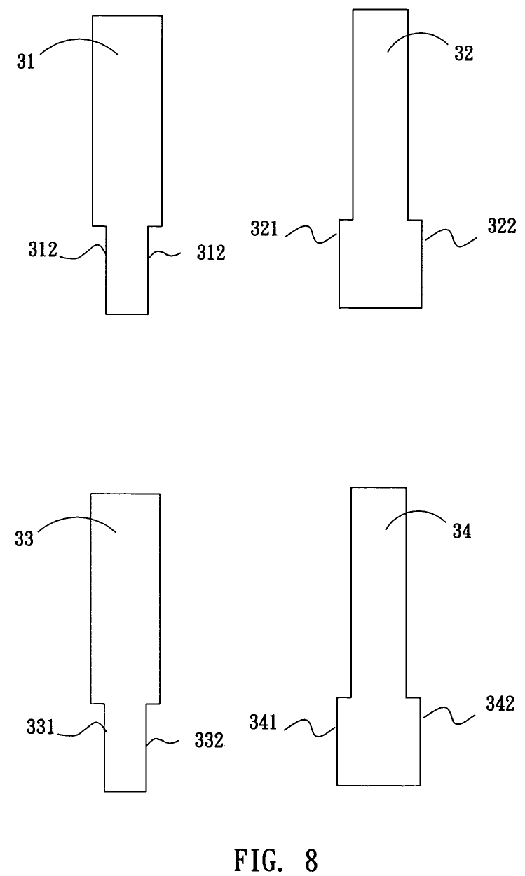

The first insertion part 311 and the second insertion part 321 are inserted into each other. The third insertion part 322 and the fourth insertion part 331 are inserted into each other. The fifth insertion part 332 and the sixth insertion part 341 are inserted into each other. The seventh insertion part 342 and the eighth insertion part 312 are inserted into each other. Finally, we obtain the light tunnel 3 shown in FIG. 6.

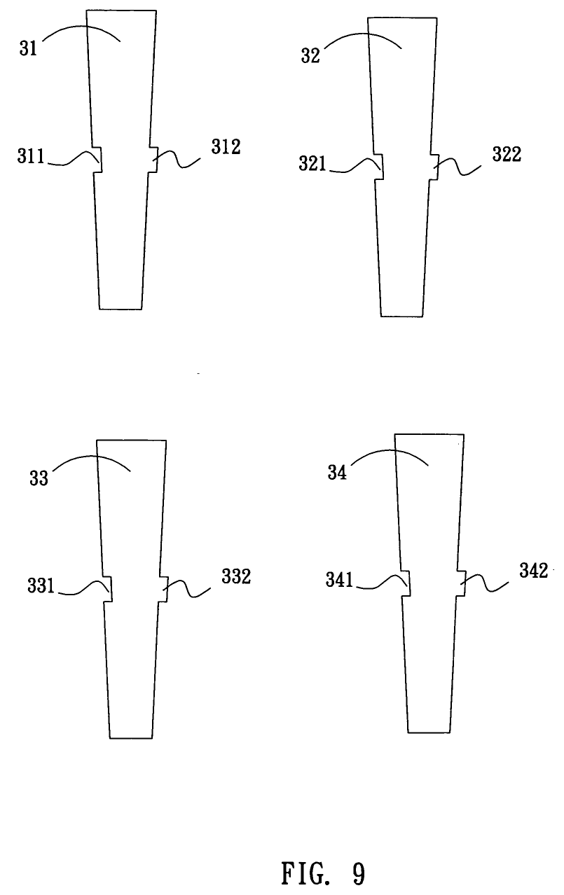

Through different thickness or designs of the insertion parts of the optical devices, we obtain a light tunnel 3′ as shown in FIG. 7. The insertion parts of the optical devices are inserted into each other.

It is worth mentioning here that the optical devices form a light passing space, as shown in both FIGS. 3 and 6. Highly reflective layers 313, 323, 333, 343 are formed on the surfaces of the sides of the optical devices facing the light passing space. The highly reflective layer can be a mirror for the entering light beams to have total reflections. Thus, the light tunnel 3 (or 3′) has the function of guiding and converging light. The brightness distribution becomes more homogeneous. Moreover, the aspect ratio of the projected beam of light can be appropriately controlled.

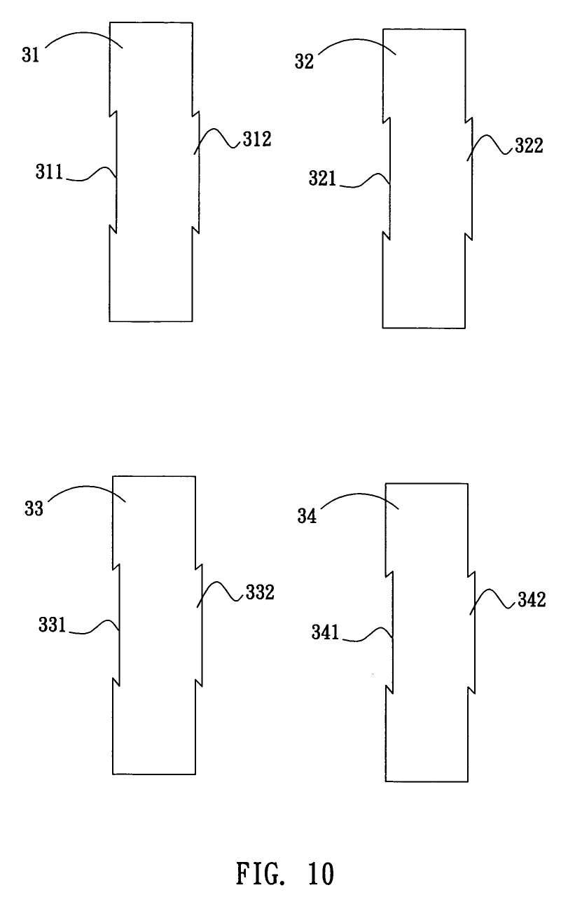

In the current embodiment, the optical device is a pane of glass. It can have the shape of a rectangle (FIGS. 5 and 8), a trapezoid (FIG. 9), a parallelogram or other polygons. Two panes of glasses can form one repetition unit, and two repetition units form a light tunnel 3. In FIGS. 5 and 8, the first optical device 31 is equivalent to the third optical device 33, and the second optical device 32 is equivalent to the fourth optical device 34. Therefore, the light tunnel 3 is comprised of two pieces of the first optical devices 31 and two pieces of the second optical devices 32. Moreover, as shown in FIGS. 9 and 10, the first optical device 31, the second optical device 32, the third optical device 33, and the fourth optical device 34 have the same shape. Each of them has a convex part and a concave part in order to form a light tunnel by insertion.

In the current embodiment, the insertion parts 311, 312, 331, 332 are concave. Their shapes can be hemispherical or polygonal (such as the rectangle in FIGS. 5 and 11, triangle, and tuxedo as in FIG. 10). The insertion parts 321, 322, 341, 342 are convex. Their shapes can be hemispherical or polygonal (such as the rectangle in FIGS. 5 and 11, triangle, and tuxedo as in FIG. 10) in order to match the insertion parts 311, 312, 331, 332. In addition, the insertion parts 311, 312, 331, 332 can be concave while the insertion parts 321, 322, 341, 342 are convex.

As shown in FIG. 11, the optical device can have several insertion parts. The first optical device 31′ has four insertion parts 311′, 312′, 313′, 314′ matching the insertion parts 343′, 344′ of the fourth optical device 34′ and the insertion parts 321′, 322′ of the second optical device 32′. The insertion parts 323′, 324′ of the second optical device 32′ match the insertion parts 331′, 332′ of the third optical device 33′. The insertion parts 333′, 334′ of the third optical device 33′ match with the insertion parts 341′, 342′ of the fourth optical device 34′.

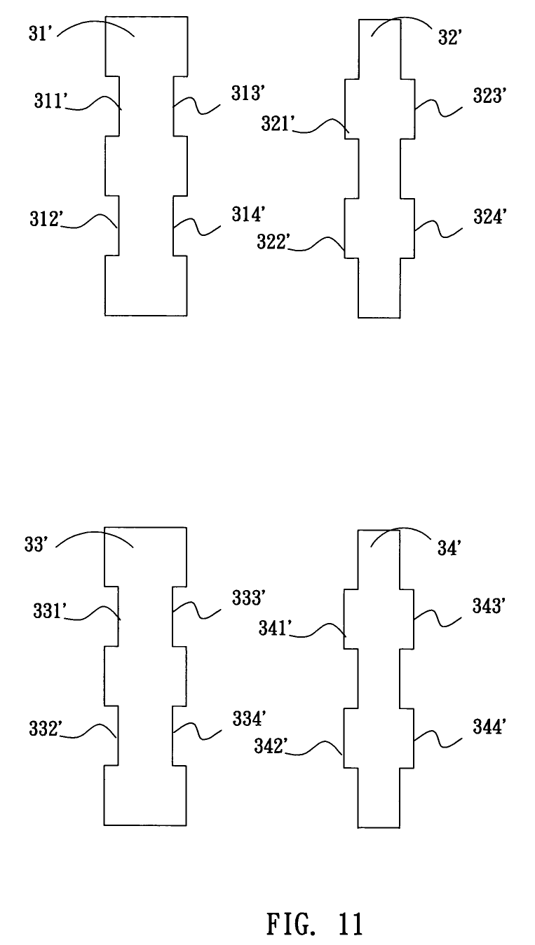

With reference to FIG. 12, the trapezoid light tunnel 3″ is comprised of a first optical device 31, a second optical device 32, a third optical device 33, and a fourth optical device 34 inserted into each other. The optical devices 31, 32, 33, 34 are trapezoid. The light tunnel 3″ is perpendicular to the cross sections of the light propagation. The cross sections are rectangles of different sizes. That is, the rectangular cross section along the A-A′ line is greater than that along the B-B′ line. Of course, the cross sections perpendicular to the light propagation direction may have other shapes such as a parallelogram according to the shapes of the optical devices and their insertion angles.

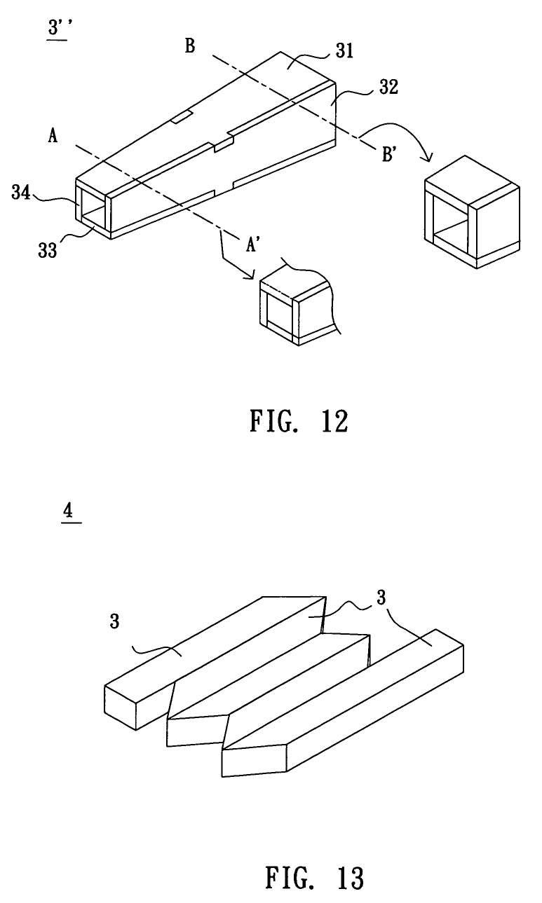

Aside from the single tunnel style shown in FIGS. 3, 6, 7, and 12, the light tunnel 4 can have multi-tunnels as shown in FIG. 13. In this case, there are several light tunnels 3. The combination of the optical devices also has at least two optical devices inserted into each other. Using the adhesive, the optical devices form a light tunnel 4 with multiple tunnels.

In summary, the disclosed light tunnel has at least two optical devices inserted into each other. In comparison with the prior art, the invention is harder to break due to the mechanical strength of the glass in the insertion parts stronger than that of the adhesive at high temperature. That is, the light tunnel not only uses the adhesive to fix optical devices but also strengthens the overall mechanical force of the light tunnel through insertions. Therefore, the invention also increases the reliability of the products. The optical devices with insertion parts also help improve the positioning and assembly of the light tunnel.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A light tunnel, comprising:
a first optical device;
a second optical device, which is adhered to the first optical device at a first angle;
a third optical device, which is adhered to the second optical device at a second angle; and
a fourth optical device, which is adhered to the third optical device at a third angle and to the first optical device at a fourth angle,
wherein at least two of the optical devices are inserted into each other and the optical devices form a light passing space, with highly reflective layers formed on the surfaces of the optical devices facing the light passing space.

2. The light tunnel of claim 1, wherein the first angle, the second angle, the third angle, and the fourth angle has a sum of 360 degrees.

3. The light tunnel of claim 1, wherein the first optical device has a first insertion part and the second optical device has a second insertion part, with the first insertion part and the second insertion part inserted into each other.

4. The light tunnel of claim 3, wherein the first insertion part is concave and the second insertion part is convex.

5. The light tunnel of claim 3, wherein the second optical device has a third insertion part and the third optical device has a fourth insertion part, with the third insertion part and the fourth insertion part inserted into each other.

6. The light tunnel of claim 5, wherein the fourth insertion part is concave and the third insertion part is convex.

7. The light tunnel of claim 3, wherein the first optical device has a eighth insertion part, the third optical device has a fifth insertion part, the fourth optical device has a sixth insertion part and a seventh insertion part, with the fifth and sixth insertion parts inserted into each other and the seventh and eighth insertion parts inserted into each other.

8. The light tunnel of claim 3, wherein the fifth and the eighth insertion parts are concave while the sixth and the seventh insertion parts are convex.

9. The light tunnel of claim 4, wherein the convex parts are polygonal.

10. The light tunnel of claim 6, wherein the convex parts are polygonal.

11. The light tunnel of claim 8, wherein the convex parts are polygonal.

12. The light tunnel of claim 4, wherein the concave parts are polygonal.

13. The light tunnel of claim 6, wherein the concave parts are polygonal.

14. The light tunnel of claim 8, wherein the concave parts are polygonal.

15. The light tunnel of claim 1, wherein the optical device are panes of glasses.

16. The light tunnel of claim 1, wherein the cross section of the light tunnel is trapezoid, rectangular or parallelogram.

17. The light tunnel of claim 1, wherein the adhesion of the optical devices is achieved by applying an adhesive at the joint parts.

18. The light tunnel of claim 17, wherein the adhesive is a light-cured adhesive or a heat-cured adhesive.

19. The light tunnel of claim 1, wherein the cross section of the light tunnel is rectangular, rectangular or parallelogram.

20. The light tunnel of claim 1, wherein the light tunnel is selected from the group comprising the single-tunnel type and the multi-tunnel type.
